(19) United States
(12) Patent Application Publication
(10) Pub. No.: US 2023/0217201 A1
(43) Pub. Date: Jul. 6, 2023

(54) AUDIO FILTER EFFECTS VIA SPATIAL TRANSFORMATIONS

(71) Applicant: META PLATFORMS TECHNOLOGIES, LLC, Menlo Park, CA (US)

(72) Inventors: Andrew Lovitt, Redmond, WA (US); Scott Phillip Selfon, Kirkland, WA (US)

(21) Appl. No.: 17/567,795

(22) Filed: Jan. 3, 2022

(51) Int. Cl. H04S 7/00; G10L 17/02; G10L 15/04; G06T 13/00

(52) U.S. Cl. CPC H04S 7/302; G10L 17/02; G10L 15/04; G06T 13/00; H04S 2420/01

(57) ABSTRACT

An audio system of a client device applies transformations to audio received over a computer network. The transformations (e.g., HRTFs) effect changes in apparent source positions of the received audio, or of segments thereof. Such transformations may be used to achieve “animation” of audio, in which the source positions of the audio or audio segments appear to change over time (e.g., circling around the listener). Additionally, segmentation of audio into distinct semantic audio segments, and application of separate transformations for each audio segment, can be used to intuitively differentiate the different audio segments by causing them to sound as if they emanated from different positions around the listener.

### BACKGROUND

This disclosure relates generally to processing of digital audio, and more specifically to audio processing using spatial transformations to achieve the effect of localizing the audio to different points in space relative to the listener.

### SUMMARY

An audio system of a client device applies transformations to audio received over a computer network. The transformations (e.g., HRTFs) effect changes in apparent spatial positions of the received audio, or of segments thereof. Such apparent positional changes can be used to achieve various different effects. For example, the transformations may be used to achieve “animation” of audio, in which the source positions of the audio or audio segments appear to change over time (e.g., circling around the listener). This is achieved by repeatedly, over time, modifying the transformation used to set the perceived position of the volume. Additionally, segmentation of audio into distinct semantic audio segments, and application of separate transformations for each audio segment, can be used to intuitively differentiate the different audio segments by causing them to sound as if they emanated from different positions around the listener.

### BRIEF DESCRIPTION OF THE DRAWINGS

FIG. 1 is a block diagram illustrating an environment in which audio transformations are performed, according to some embodiments.

FIG. 2 is a block diagram of an audio system, in accordance with one or more embodiments.

FIGS. 3-5 illustrate the interactions between the various actors and components of FIG. 1 when transforming audio to produce an audio “animation”, or when performing audio segmentation and “repositioning,” according to some embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

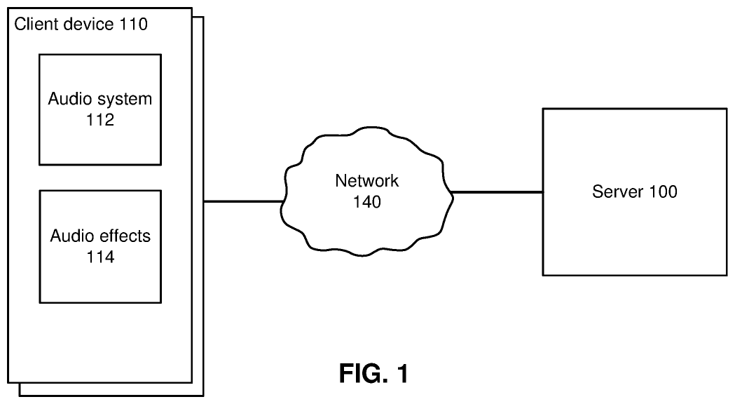

FIG. 1 is a block diagram illustrating an environment in which audio transformations are performed, according to some embodiments. A client device 110 of a user receives audio over a computer network. There may many different configurations of client devices 110 and servers 100, according to different embodiments. For example, in some embodiments two or more client devices 110 carry out a real-time conversation, e.g., using audio, or video containing audio. In such embodiments, the conversation may be mediated by a server 100, or (alternatively) it may be peer-to-peer, without a mediating server. As another example, in some embodiments one or more client devices 110 receives audio (e.g., a podcast or audiobook, or data for a videoconference containing audio), either from or via a server 100, or in a peer-to-peer fashion.

In each of the various embodiments, a client device 110 has an audio system 112 that applies audio filters that effect spatial transformations to change the quality of the audio. For example, the audio system 112 can transform received audio to change its perceived source location with respect to the listening user. This perceived source location can change over time, resulting in seemingly moving audio, a form of audio “animation.” For instance, the perceived source location can be varied over time to create a perception that an object producing the sound is circling in the air overhead, or is bouncing around the room of the listener. As another example, the audio system 112 can perform separate spatial transformations on different portions of the audio to create the impression that different speakers or objects are in different locations with respect to the listener. For instance, the audio system 112 could identify the different voices in audio of a presidential debate and apply different spatial transformations to each, creating the impression that one candidate was speaking from the listener's left side, the other candidate was speaking from the listener's right side, and the moderator was speaking from directly ahead of the listener.

The client device(s) 110 can be various different types of computing devices capable of communicating with audio, such as virtual reality (VR) head-mounted displays (HMDs), audio headsets, augmented reality (AR) glasses with speakers, smart phones, smart speaker systems, laptop or desktop computers, or the like. As noted, the client devices 110 have audio system 112 that process audio and perform spatial transformations of the audio to achieve spatial effects.

The network 140 may be any suitable communications network for data transmission. In an embodiment such as that illustrated in FIG. 1, the network 140 uses standard communications technologies and/or protocols and can include the Internet. In another embodiment, the entities use custom and/or dedicated data communications technologies.

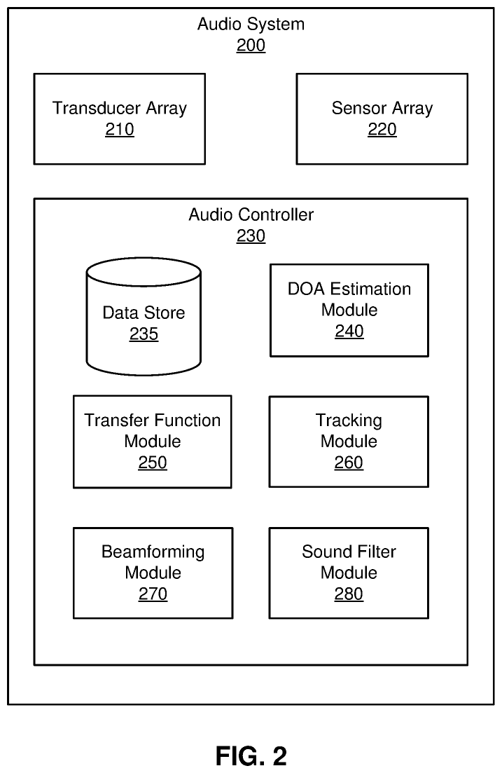

FIG. 2 is a block diagram of an audio system 200, in accordance with one or more embodiments. The audio system 112 in FIG. 1 may be an embodiment of the audio system 200. The audio system 200 performs processing on audio, including applying spatial transformations to audio. The audio system 200 further generates one or more acoustic transfer functions for a user. The audio system 200 may then use the one or more acoustic transfer functions to generate audio content for the user, such as applying spatial transformations. In the embodiment of FIG. 2, the audio system 200 includes a transducer array 210, a sensor array 220, and an audio controller 230. Some embodiments of the audio system 200 have different components than those described here. Similarly, in some cases, functions can be distributed among the components in a different manner than is described here.

The transducer array 210 is configured to present audio content. The transducer array 210 includes one or more transducers. A transducer is a device that provides audio content. A transducer may be, e.g., a speaker, or some other device that provides audio content. When the client device 110 into which the audio system 200 is incorporated is a device such as a VR headset or AR glasses, the transducer array 210 may include a tissue transducer. A tissue transducer may be configured to function as a bone conduction transducer or a cartilage conduction transducer. The transducer array 210 may present audio content via air conduction (e.g., via one or more speakers), via bone conduction (via one or more bone conduction transducer), via cartilage conduction (via one or more cartilage conduction transducers), or some combination thereof. In some embodiments, the transducer array 210 may include one or more transducers to cover different parts of a frequency range. For example, a piezoelectric transducer may be used to cover a first part of a frequency range and a moving coil transducer may be used to cover a second part of a frequency range.

The bone conduction transducers (if any) generate acoustic pressure waves by vibrating bone/tissue in the user's head. A bone conduction transducer may be coupled to a portion of a headset, and may be configured to be behind the auricle coupled to a portion of the user's skull. The bone conduction transducer receives vibration instructions from the audio controller 230, and vibrates a portion of the user's skull based on the received instructions. The vibrations from the bone conduction transducer generate a tissue-borne acoustic pressure wave that propagates toward the user's cochlea, bypassing the eardrum.

The cartilage conduction transducers generate acoustic pressure waves by vibrating one or more portions of the auricular cartilage of the ears of the user. A cartilage conduction transducer may be coupled to a portion of a headset, and may be configured to be coupled to one or more portions of the auricular cartilage of the ear. For example, the cartilage conduction transducer may couple to the back of an auricle of the ear of the user. The cartilage conduction transducer may be located anywhere along the auricular cartilage around the outer ear (e.g., the pinna, the tragus, some other portion of the auricular cartilage, or some combination thereof). Vibrating the one or more portions of auricular cartilage may generate: airborne acoustic pressure waves outside the ear canal; tissue born acoustic pressure waves that cause some portions of the ear canal to vibrate thereby generating an airborne acoustic pressure wave within the ear canal; or some combination thereof. The generated airborne acoustic pressure waves propagate down the ear canal toward the ear drum. A small portion of the acoustic pressure waves may propagate into the local area.

The transducer array 210 generates audio content in accordance with instructions from the audio controller 230. The audio content may be spatialized. Spatialized audio content is audio content that appears to originate from a particular direction and/or target region (e.g., an object in the local area and/or a virtual object). For example, spatialized audio content can make it appear that sound is originating from a virtual singer across a room from a user of the audio system 200. The transducer array 210 may be coupled to a wearable client device (e.g., a headset). In alternate embodiments, the transducer array 210 may be a plurality of speakers that are separate from the wearable device (e.g., coupled to an external console).

The transducer array 210 may include one or more speakers in a dipole configuration. The speakers may be located in an enclosure having a front port and a rear port. A first portion of the sound emitted by the speaker is emitted from the front port. The rear port allows a second portion of the sound to be emitted outwards from the rear cavity of the enclosure in a rear direction. The second portion of the sound is substantially out of phase with the first portion emitted outwards in a front direction from the front port.

In some embodiments, the second portion of the sound has a (e.g., 180°) phase offset from the first portion of the sound, resulting overall in dipole sound emissions. As such, sounds emitted from the audio system experience dipole acoustic cancellation in the far-field where the emitted first portion of the sound from the front cavity interfere with and cancel out the emitted second portion of the sound from the rear cavity in the far-field, and leakage of the emitted sound into the far-field is low. This is desirable for applications where privacy of a user is a concern, and sound emitted to people other than the user is not desired. For example, since the ear of the user wearing the headset is in the near-field of the sound emitted from the audio system, the user may be able to exclusively hear the emitted sound.

The sensor array 220 detects sounds within a local area surrounding the sensor array 220. The sensor array 220 may include a plurality of acoustic sensors that each detect air pressure variations of a sound wave and convert the detected sounds into an electronic format (analog or digital). The plurality of acoustic sensors may be positioned on a headset, on a user (e.g., in an ear canal of the user), on a neckband, or some combination thereof. An acoustic sensor may be, e.g., a microphone, a vibration sensor, an accelerometer, or any combination thereof. In some embodiments, the sensor array 220 is configured to monitor the audio content generated by the transducer array 210 using at least some of the plurality of acoustic sensors. Increasing the number of sensors may improve the accuracy of information (e.g., directionality) describing a sound field produced by the transducer array 210 and/or sound from the local area.

The sensor array 220 detects environmental conditions of the client device 110 into which it is incorporated. For example, the sensor array 220 detects an ambient noise level. The sensor array 220 may also detect sound sources in the local environment, such as persons speaking. The sensor array 220 detects acoustic pressure waves from sound sources and converts the detected acoustic pressure waves into analog or digital signals, which the sensor array 220 transmits to the audio controller 230 for further processing.

The audio controller 230 controls operation of the audio system 200. In the embodiment of FIG. 2, the audio controller 230 includes a data store 235, a DOA estimation module 240, a transfer function module 250, a tracking module 260, a beamforming module 270, and an audio filter module 280. The audio controller 230 may be located inside a headset client device 110, in some embodiments. Some embodiments of the audio controller 230 have different components than those described here. Similarly, functions can be distributed among the components in different manners than described here. For example, some functions of the controller may be performed external to the headset. The user may opt in to allow the audio controller 230 to transmit data captured by the headset to systems external to the headset, and the user may select privacy settings controlling access to any such data.

The data store 235 stores data for use by the audio system 200. Data in the data store 235 may include a privacy setting, attenuation levels of frequency bands associated with privacy settings, and audio filters and related parameters. The data store 235 may further include sounds recorded in the local area of the audio system 200, audio content, head-related transfer functions (HRTFs), transfer functions for one or more sensors, array transfer functions (ATFs) for one or more of the acoustic sensors, sound source locations, virtual models of local areas, direction of arrival estimates, and other data relevant for use by the audio system 200, or any combination thereof. The data store 235 may include observed or historical ambient noise levels in a local environment of the audio system 200, and/or a degree of reverberation or other room acoustics properties of particular rooms or other locations. The data store 235 may include properties describing sound sources in a local environment of the audio system 200, such as whether sound sources are typically humans speaking; natural phenomena such as wind, rain, or waves; machinery; external audio systems; or any other type of sound source.

The DOA estimation module 240 is configured to localize sound sources in the local area based in part on information from the sensor array 220. Localization is a process of determining where sound sources are located relative to the user of the audio system 200. The DOA estimation module 240 performs a DOA analysis to localize one or more sound sources within the local area. The DOA analysis may include analyzing the intensity, spectra, and/or arrival time of each sound at the sensor array 220 to determine the direction from which the sounds originated. In some cases, the DOA analysis may include any suitable algorithm for analyzing a surrounding acoustic environment in which the audio system 200 is located.

For example, the DOA analysis may be designed to receive input signals from the sensor array 220 and apply digital signal processing algorithms to the input signals to estimate a direction of arrival. These algorithms may include, for example, delay and sum algorithms where the input signal is sampled, and the resulting weighted and delayed versions of the sampled signal are averaged together to determine a DOA. A least mean squared (LMS) algorithm may also be implemented to create an adaptive filter. This adaptive filter may then be used to identify differences in signal intensity, for example, or differences in time of arrival. These differences may then be used to estimate the DOA. In another embodiment, the DOA may be determined by converting the input signals into the frequency domain and selecting specific bins within the time-frequency (TF) domain to process. Each selected TF bin may be processed to determine whether that bin includes a portion of the audio spectrum with a direct path audio signal. Those bins having a portion of the direct-path signal may then be analyzed to identify the angle at which the sensor array 220 received the direct-path audio signal. The determined angle may then be used to identify the DOA for the received input signal. Other algorithms not listed above may also be used alone or in combination with the above algorithms to determine DOA.

In some embodiments, the DOA estimation module 240 may also determine the DOA with respect to an absolute position of the audio system 200 within the local area. The position of the sensor array 220 may be received from an external system (e.g., some other component of a headset, an artificial reality console, a mapping server, a position sensor, etc.). The external system may create a virtual model of the local area, in which the local area and the position of the audio system 200 are mapped. The received position information may include a location and/or an orientation of some or all of the audio system 200 (e.g., of the sensor array 220). The DOA estimation module 240 may update the estimated DOA based on the received position information.

The transfer function module 250 is configured to generate one or more acoustic transfer functions. Generally, a transfer function is a mathematical function giving a corresponding output value for each possible input value. Based on parameters of the detected sounds, the transfer function module 250 generates one or more acoustic transfer functions associated with the audio system. The acoustic transfer functions may be array transfer functions (ATFs), head-related transfer functions (HRTFs), other types of acoustic transfer functions, or some combination thereof. An ATF characterizes how the microphone receives a sound from a point in space. In the description below, HRTFs are often referenced, though other types of acoustic transfer functions could also be used.

An ATF includes a number of transfer functions that characterize a relationship between the sound source and the corresponding sound received by the acoustic sensors in the sensor array 220. Accordingly, for a sound source there is a corresponding transfer function for each of the acoustic sensors in the sensor array 220. Collectively, the set of transfer functions is referred to as an ATF. Accordingly, for each sound source there is a corresponding ATF. Note that the sound source may be, e.g., someone or something generating sound in the local area, the user, or one or more transducers of the transducer array 210. The ATF for a particular sound source location relative to the sensor array 220 may differ from user to user due to a person's anatomy (e.g., ear shape, shoulders, etc.) that affects the sound as it travels to the person's ears. Accordingly, in some embodiments the ATFs of the sensor array 220 are personalized for each user of the audio system 200.

In some embodiments, the transfer function module 250 determines one or more HRTFs or other acoustic transfer functions for a user of the audio system 200. The HRTF (or other acoustic transfer function) characterizes how an ear receives a sound from a point in space. The HRTF for a particular source location relative to a person is unique to each ear of the person (and is unique to the person) due to the person's anatomy (e.g., ear shape, shoulders, etc.) that affects the sound as it travels to the person's ears. In some embodiments, the transfer function module 250 may determine HRTFs for the user using a calibration process. In some embodiments, the HTRFs may be location-specific, and may be generated to take acoustic properties of the current location into account (such as reverberation); alternatively, the HRTFs may be supplemented by additional transformations to take location-specific acoustic properties into account.

In some embodiments, the transfer function module 250 may provide information about the user to a remote system. The user may adjust privacy settings to allow or prevent the transfer function module 250 from providing the information about the user to any remote systems. The remote system determines a set of HRTFs that are customized to the user using, e.g., machine learning, and provides the customized set of HRTFs to the audio system 200.

The tracking module 260 is configured to track locations of one or more sound sources. The tracking module 260 may compare current DOA estimates and compare them with a stored history of previous DOA estimates. In some embodiments, the audio system 200 may recalculate DOA estimates on a periodic schedule, such as once per second, or once per millisecond. The tracking module may compare the current DOA estimates with previous DOA estimates, and in response to a change in a DOA estimate for a sound source, the tracking module 260 may determine that the sound source moved. In some embodiments, the tracking module 260 may detect a change in location based on visual information received from the headset or some other external source. The tracking module 260 may track the movement of one or more sound sources over time. The tracking module 260 may store values for a number of sound sources and a location of each sound source at each point in time. In response to a change in a value of the number or locations of the sound sources, the tracking module 260 may determine that a sound source moved. The tracking module 260 may calculate an estimate of the localization variance. The localization variance may be used as a confidence level for each determination of a change in movement.

The beamforming module 270 is configured to process one or more ATFs to selectively emphasize sounds from sound sources within a certain area while de-emphasizing sounds from other areas. In analyzing sounds detected by the sensor array 220, the beamforming module 270 may combine information from different acoustic sensors to emphasize sound associated from a particular region of the local area while deemphasizing sound that is from outside of the region. The beamforming module 270 may isolate an audio signal associated with sound from a particular sound source from other sound sources in the local area based on, e.g., different DOA estimates from the DOA estimation module 240 and the tracking module 260. The beamforming module 270 may thus selectively analyze discrete sound sources in the local area. In some embodiments, the beamforming module 270 may enhance a signal from a sound source. For example, the beamforming module 270 may apply audio filters which eliminate signals above, below, or between certain frequencies. Signal enhancement acts to enhance sounds associated with a given identified sound source relative to other sounds detected by the sensor array 220.

The audio filter module 280 determines audio filters for the transducer array 210. The audio filter module 280 may generate an audio filter used to adjust an audio signal to mitigate sound leakage when presented by one or more speakers of the transducer array based on the privacy setting. The audio filter module 280 receives instructions from the sound leakage attenuation module 290. Based on the instruction received from the sound leakage attenuation module 290, the audio filter module 280 applies audio filters to the transducer array 210 which decrease sound leakage into the local area.

In some embodiments, the audio filters cause the audio content to be spatialized, such that the audio content appears to originate from a target region. The audio filter module 280 may use HRTFs and/or acoustic parameters to generate the audio filters. The acoustic parameters describe acoustic properties of the local area. The acoustic parameters may include, e.g., a reverberation time, a reverberation level, a room impulse response, etc. In some embodiments, the audio filter module 280 calculates one or more of the acoustic parameters. In some embodiments, the audio filter module 280 requests the acoustic parameters from a mapping server (e.g., as described below with regard to FIG. 8). The audio filter module 280 provides the audio filters to the transducer array 210. In some embodiments, the audio filters may cause positive or negative amplification of sounds as a function of frequency.

The audio system 200 may be part of a headset or some other type of client device 110. In some embodiments, the audio system 200 is incorporated into a smart phone client device. The phone may also be integrated into the headset or separate but communicatively coupled to the headset.

Returning to FIG. 1, the client device 110 has an audio effects module 114 that transforms audio for listeners of the audio, such as the owner of the client device. The audio effects module 114 may use the audio system 112 to achieve the transformations.

The audio effects module 114 may achieve different types of effects for audio in different embodiments. One type of audio effect is an audio “animation,” in which the position of audio is changed over time to simulate movement of a voice or sound-emitting object. For example, such audio animations can include:
varying the position of the audio in a circular fashion over time, at a position such that the audio appears to be circling in the air above the listener.
varying the position of the audio to simulate the audio moving in a bouncing motion, as if the audio were being emitted by a ball or other bouncing object.
varying the position of the audio to simulate rapidly expanding outward, as if the audio were moving along with an explosion.
varying the position of the audio to simulate moving from a far-away location toward the listener, and then away from the user, as if traveling in a vehicle. The intensity of the audio can also be varied concurrently with the change in position, such as with oscillating volume (e.g., simulating an ambulance siren).

To produce such audio “animations,” the audio effects module 114 adjusts the perceived position of the audio at numerous time intervals, such as fixed periods (e.g., every 5 ms). For example, the audio effects module 114 may cause the transfer function module 250 of the audio system 112 to generate a sequence of numerous different acoustic transfer functions (e.g., HRTFs) that when applied over time simulate motion of the audio. For example, to simulate audio circling in the air above the listener, a number of HRTFs can be generated to correspond to different positions along a circular path in a horizontal plane above the listener's head. After the elapse of some time period (e.g., 5 ms), the next HRTF in the generated sequence can be applied to a next portion of audio, thereby simulating a circular path for the audio.

Another type of audio effect performed in some embodiments is audio segmentation and relocation, in which distinct semantic components of the audio have different spatial transformations applied to them so that they appear to have different positions. The distinct semantic components correspond to different portions of the audio that a human user would tend to recognize as representing semantically-distinct audio sources, such as (for example) different voices in a conversation, different sound-emitting objects (e.g., cannons, thunder, enemies, etc.) in a movie or video game, or the like. In some embodiments, the received audio already contains metadata that expressly indicates the distinct semantic components of the audio. The metadata may contain additional associated data, such as suggested positions for the different semantic components with respect to the listener. In other embodiments, the audio does not contain any such metadata, and so the audio effects module instead performs audio analysis to identify distinct semantic components within the audio, such as with voice identification, with techniques for distinguishing speech from non-speech, or with semantic analysis. The audio effects module 114 uses the audio system 112 to configure different acoustic transfer functions (e.g., HRTFs) for the different semantic components of the audio. In this way, the different semantic components may be made to sound as if they were located in different positions in the space around the listener. For example, for the audio of a podcast or dramatized audiobook, the audio effects module 114 could treat each distinct voice as a different semantic component and use a different HRTF for each voice, so that each voice appears to be coming from a different position around the user. This enhances the feeling of distinctiveness of the different voices. If the audio contains metadata with suggested positions for the various voices (and where the positions of each voice can vary over time, as the corresponding character moves within the scene), the audio effects module 114 can use those suggested positions, rather than selecting its own positions for each voice.

In some embodiments, the audio effects module 114 obtains information about the physical environment around the client device and uses it to set the positions of the audio or audio components. For example, where the client device is, or is communicatively coupled to, a headset or other device with visual analysis capabilities, the client device may use those capabilities to automatically approximate the size and position of a room in which the client device is located, and may position the audio or audio components to be within the room.

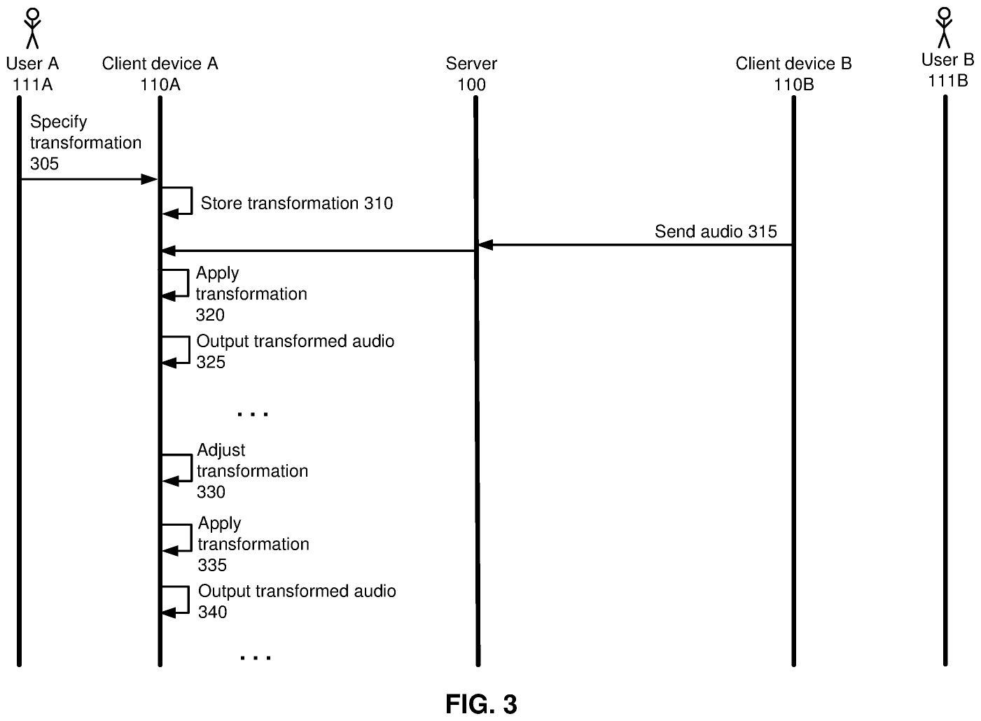

FIG. 3 illustrates interactions between the various actors and components of FIG. 1 when transforming audio to produce an audio “animation,” according to some embodiments.

A user 111A using a first client device 110A specifies 305 that a given transformation should be applied to some or all of the audio. Step 305 could be accomplished via a user interface of an application that the user 111A uses to obtain audio, such as a chat or videoconference application for an interactive conversation, an audio player for songs, or the like. For example, the user interface could list a number of different possible transformations (e.g., adjusting the pitch of the audio, or of audio components such as voices; audio “animation”; audio segmentation and location; etc.), and the user 111A could select one or more transformations from that list. The audio effects module 114 of the client device 110A stores 310 an indication that the transformation should be used thereafter.

At some later point, the client device 110B sends 315 audio to the client device 110, e.g., via a server 100. The type of audio depends upon the embodiment, and could include real-time conversations (e.g., pure voice, or voice within a videoconference) with a user 111B (and possibly other users, as well), non-interactive audio such as songs or podcast audio, or the like. The audio can be received in different manners, such as by streaming, or by downloading of the complete audio data prior to playback.

The audio effects module 114 applies 320 the transformation to a portion of the audio. The transformation is applied by generating an acoustic transfer function, such as an HRTF, that carries out the transformation. The acoustic transfer function can be customized for the user 111A, based on the specific auditory properties of the user, leading to the transformed audio being more accurate when listened to by the user 111A. For the purposes of the audio “animation” of FIG. 3, the acoustic transfer function carries out a change of perceived position of the audio, moving its perceived position relative to the transducer array 210 and/or to the user 111A. The audio effects module 114 outputs 325 the transformed audio (e.g., via the transducer array 210), which can then be heard by the user 111A.

In order to achieve a changing of perceived position of the audio, the audio effects module 114 repeatedly adjusts 330 the acoustic transfer function that accomplishes the transformation (where “adjusting” may include either changing the data of the acoustic transfer function, or switching to use the next one of a sequence of previously-generated acoustic transfer functions, for example), applies 335 the adjusted transformation to a next portion of the audio, and outputs the transformed audio portion. This produces the effect of the audio moving continuously. The adjustment and the transformations and application of the transformation to the audio can be repeated at fixed intervals, such as 5 ms, with the portions of audio that are transformed corresponding to the intervals (e.g., 5 ms of audio).

The steps of FIG. 3 result in a perceived continuous change of location of the audio sent in step 315, resulting in a listener perception of motion of the received audio. For example, as noted, the sound source could appear to be rotating in a circular path above the listener's head.

Although FIG. 3 depicts a conversation being mediated by a server 100, in other embodiments the conversation could be peer-to-peer between the client devices 110, without the presence of the server 100. Additionally, the audio to be transformed need not be part of a conversation between two or more users, but could be audio from a non-interactive experience, such as a song streamed from an audio server.

Further, in some embodiments the audio transformation need not take place on the same client device (that is, client device 110A) on which it is output. Although performing the transformation, and outputting the result thereof, on the same client device affords better opportunity to use transformations that are customized to the listener, it is also possible to perform user-agnostic transformations on one client device and output the result on another client device. Thus, for example, in other embodiments, notice of the transformation specified in step 305 of FIG. 3 is provided to client device 110B, and client device 110B performs the transformations (albeit not necessarily with a transformation specifically customized for user 111A) and adjustments of transformations, providing the transformed audio to the client device 110A, which in turns outputs the transformed audio for the user 111A.

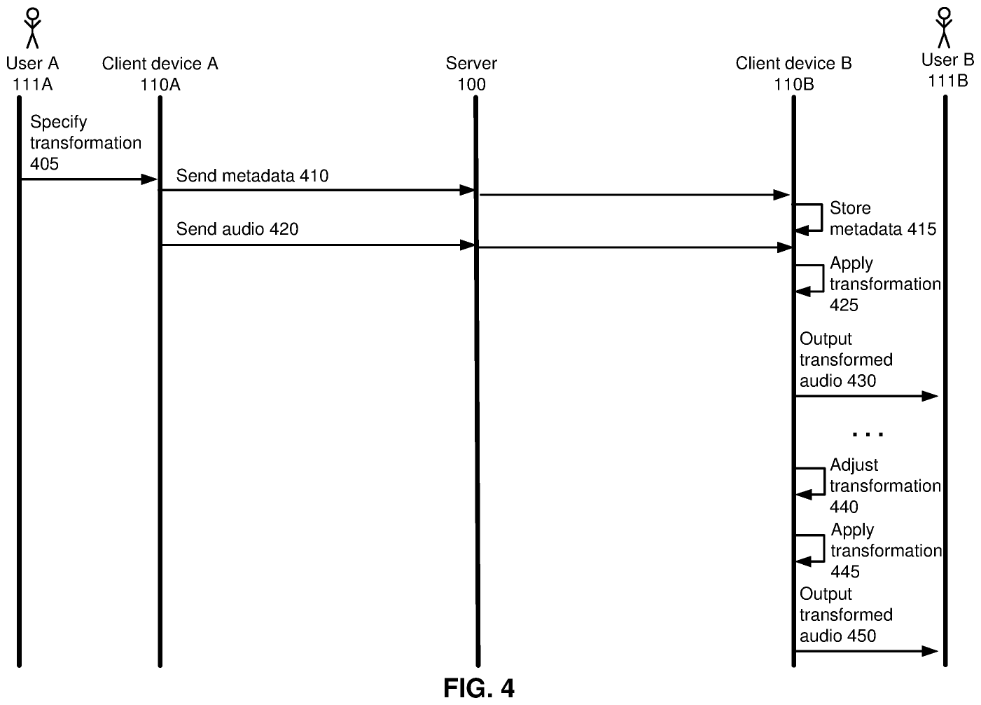

FIG. 4 illustrates the interactions between the various actors and components of FIG. 1 when transforming audio to produce an audio “animation” on the audio that the user sends, according to some embodiments.

As in FIG. 3, step 305, the user 111A specifies 405 a transformation. However, this transformation specifies that the audio of the user 111A that is sent to user 111B should be transformed, not the audio received from the client device 110B. Accordingly, the audio effects module 114 of the client device 110A sends 410 metadata to the client device 110B, requesting that the audio from the user 111A be transformed according to the transformation. (This allows the user 111A to specify that the user 111B should hear the voice of the user 111A as if it is circling in the air, for example.) the audio effects module 114 of the client device 110B accordingly stores an indicator of this request for transformations, and later repeatedly over time adjusts and applies the transformation to audio, outputting the transformed audio. As in FIG. 3, this simulates movement of the audio—the audio originating from the user 111A, in this case.

As with FIG. 3, other variations—such as the absence of an intermediary server 100—are also possible.

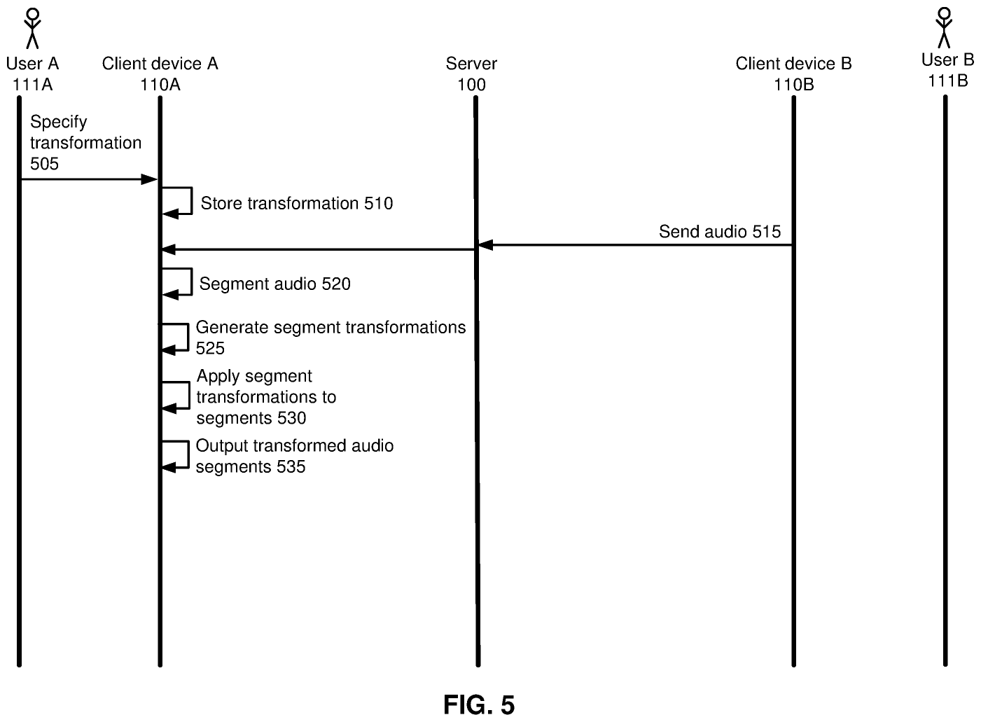

FIG. 5 illustrates the interactions between the various actors and components of FIG. 1 when performing audio segmentation and “repositioning,” according to some embodiments.

As in FIG. 3, step 305, the user 111A specifies 505 a transformation, and the client device 110 stores 510 an indication of the requested transformation. The specified transformation is a segmentation and repositioning transformation, which segments received audio into different semantic audio units. For example, different segments could be different voices, different types of sound (human voices, animal sounds, sound effects, etc.).

The client device 110B (or server 100) sends 515 audio to the client device 110A. The audio effects module 114 of the client device 110A segments 520 the audio into different semantic audio units. In some embodiments, the audio itself contains metadata that distinguishes the different segments (and that may also suggest spatial positions for outputting the audio segments); in such cases, the audio effects module 114 can simply identify the segments from the included metadata. In embodiments in which the audio does not contain such metadata, the audio effects module 114 itself segments the audio into its different semantic components.

With the segments identified, the audio effects module 114 generates 525 different transformations for the different segments. For example, the transformations may alter the apparent source spatial position of each audio segment, so that they appear to emanate from different locations around the user. The spatial positions achieved by the various transformations may be determined based on suggested positions for the audio segments within metadata (if any) of the audio; if no such metadata is present, then the spatial positions may be determined by other means, such as random allocation of the different audio segments to a set of predetermined positions. The positions may be determined according to the number of audio segments, such as a left-hand position and a right-hand position, in the case of two distinct audio segments.

The audio effects module 114 applies 530 the segment transformations to the data of their corresponding audio segments, and outputs 535 the transformed audio segments, thereby achieving different effects for the different segments, such as different apparent spatial positions for the different audio segments. For example, the voices of two candidates in a presidential debate might be made to appear to originate on the left and on the right of the listener.

Additional Configuration Information

The foregoing description of the embodiments of the disclosure has been presented for the purpose of illustration; it is not intended to be exhaustive or to limit the disclosure to the precise forms disclosed. Persons skilled in the relevant art can appreciate that many modifications and variations are possible in light of the above disclosure.

Some portions of this description describe the embodiments of the disclosure in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the disclosure may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the disclosure may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments is intended to be illustrative, but not limiting, of the scope of the disclosure, which is set forth in the following claims.

What is claimed is:

1. A computer-implemented method of a client device for animating audio locations within a conversation, the method comprising:
receiving, from a first user, a specification of a positional audio effect that when applied to audio causes the audio to appear to emanate from a particular position with respect to the client device;
generating an acoustic transfer function corresponding to the positional audio effect;
receiving audio from a second client device; and
repeatedly, over portions of a time interval:
adjusting the acoustic transfer function according to a next portion of the time interval;
applying the adjusted acoustic transfer function to a portion of the audio corresponding to the next portion of the time interval, thereby obtaining a transformed audio portion; and
outputting the transformed audio portion to the first user;
wherein the repeated adjusting, applying, and outputting cause a perceived position of the audio to change over the time interval.

2. The computer-implemented method of claim 1, wherein the acoustic transfer function is generated to be specific to anatomy of the first user.

3. The computer-implemented method of claim 1, wherein the acoustic transfer function is generated at least in part based on acoustic properties of a current location of the client device.

4. The computer-implemented method of claim 1, wherein the acoustic transfer function is a head-related transfer function (HRTF).

5. The computer-implemented method of claim 1, wherein the repeated adjusting, applying, and outputting cause a perceived position of the audio to circle around the first user.

6. A computer-implemented method of a client device for separately positioning semantically-distinct portions of audio, the method comprising:
receiving audio from a client device;
segmenting the received audio into a plurality of semantic audio components corresponding to semantically-distinct audio sources;
generating a plurality of different acoustic transfer functions corresponding to the plurality of semantic audio components, each acoustic transfer function causing audio to which it is applied to appear to emanate from a given position relative to the client device;
applying each acoustic transfer function to its corresponding semantic audio component to generate a transformed semantic audio component; and
outputting the transformed semantic audio segments, such that each transformed semantic audio component sounds as if it emanates from a different spatial position relative to the client device.

7. The computer-implemented method of claim 6, wherein the received audio is a podcast or an audiobook, and wherein at least some of the semantic audio components correspond to different voices within the received audio.

8. The computer-implemented method of claim 6, wherein the received audio contains metadata identifying different semantic audio components of the received audio, and wherein segmenting the received audio components comprises analyzing the metadata.

9. The computer-implemented method of claim 6, wherein the received audio lacks metadata identifying different semantic audio components of the received audio, and wherein segmenting the received audio components comprises using voice identification techniques to recognize different voices within the received audio.

10. The computer-implemented method of claim 6, wherein the received audio lacks metadata identifying different semantic audio components of the received audio, and wherein segmenting the received audio components comprises distinguishing speech from non-speech within the received audio.

11. A non-transitory computer-readable storage medium comprising instructions that when executed by a computer processor perform actions comprising:
receiving, from a first user, a specification of a positional audio effect that when applied to audio causes the audio to appear to emanate from a particular position with respect to the client device;
generating an acoustic transfer function corresponding to the positional audio effect;
receiving audio from a second client device; and
repeatedly, over portions of a time interval:
adjusting the acoustic transfer function according to a next portion of the time interval;
applying the adjusted acoustic transfer function to a portion of the audio corresponding to the next portion of the time interval, thereby obtaining a transformed audio portion; and
outputting the transformed audio portion to the first user;
wherein the repeated adjusting, applying, and outputting cause a perceived position of the audio to change over the time interval.

12. The non-transitory computer-readable storage medium of claim 11, wherein the acoustic transfer function is generated to be specific to anatomy of the first user.

13. The non-transitory computer-readable storage medium of claim 11, wherein the acoustic transfer function is generated at least in part based on acoustic properties of a current location of the client device.

14. The non-transitory computer-readable storage medium of claim 11, wherein the acoustic transfer function is a head-related transfer function (HRTF).

15. The non-transitory computer-readable storage medium of claim 11, wherein the repeated adjusting, applying, and outputting cause a perceived position of the audio to circle around the first user.
